(19) United States
(12) Patent Application Publication
(10) Pub. No.: US 2007/0003866 A1
(43) Pub. Date: Jan. 4, 2007

(54) Photosensitive composition, photosensitive planographic printing plate material, and image forming method of the same

(75) Inventor: Yasuhiko Takamuki, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA MEDICAL & GRAPHIC, INC., Tokyo (JP)

(21) Appl. No.: 11/451,180

(22) Filed: Jun. 12, 2006

(30) Foreign Application Priority Data
Jun. 21, 2005 (JP) JP2005-180572

(51) Int. Cl. G03C 1/00

(52) U.S. Cl. 430/270.1

(57) ABSTRACT

A photosensitive composition comprising: (A) an addition-polymerizable compound containing an ethylenic double bond in the molecule; (B) an iron-arene complex which acts as a photopolymerization initiator; (C) a polymer binder; and (E) a siloxane glycol copolymer.

This application is based on Japanese Patent Application No. 2005-180572 filed on Jun. 21, 2005 in Japanese Patent Office, the entire content of which is hereby incorporated by reference.

### TECHNICAL FIELD

The present invention relates to a photosensitive planographic printing plate material employed in a computer-to-plate system (hereinafter referred to as CTP), a photosensitive composition employed in the same, and an image forming method of the planographic printing plate material employing the above photosensitive planographic printing plate material, and specifically to a photosensitive composition suitable for exposure employing a laser beam of 350-450 nm wavelengths, a photosensitive planographic printing plate material and an image forming method of a planographic printing plate material, employing the above photosensitive planographic printing plate material.

### BACKGROUND

In recent years, in the production technologies of printing plates for offset printing, developed and practiced has been CPT which directly records digital image data onto a photosensitive planographic printing plate, employing a laser beam.

Of these, in the printing field, in which a relatively long plate life is demanded, it has been known to employ negative-acting photosensitive planographic printing plate materials having a polymerizable photosensitive layer incorporating polymerizable compounds (refer, for example, to Patent Documents 1 and 2).

Further, known have been printing plate materials which exhibit enhancement of safety for safelight in view of handling of printing plates, and which are applicable to image exposure employing a laser beam of 350-450 nm wavelengths.

Further, high output and downsized blue violet lasers of 350-450 nm wavelengths have been become more readily available on the market. By developing photosensitive planographic printing plates suitable at the above laser wavelengths, room-light handling has been realized (refer, for example, to Patent Documents 3 and 4).

In order to enhance imaging speed of planographic printing plate materials carrying a polymerizable photosensitive layer, various compounds, which are employed in the photosensitive layer as a polymerization initiator, have been proposed. Examples include s-triazine compounds having a trichloromethyl group described, for example, in Japanese Patent Publication for Public Inspection (hereinafter referred to as JP-A) Nos. 48-36281, 54-74887, and 64-35548; iron arene complexes and peroxides, described for example, in JP-A No. 59-219307; monoalkyltriallyl borates, described for example, in JP-A Nos. 62-150242, 62-143044, and 64-35548; and titanocene compounds, described for example, in JP-A Nos. 63-41483 and 2-291.

Further, known are polymerization type planographic printing plate materials having a polymerizable photosensitive layer incorporating optical brightening agents as a sensitizer (refer, for example, to Patent Document 5).

On the other hand, in recent years, for CPT, a plate making process, which produces printing plates from planographic printing plate materials, has been increasingly automated. In such an automated plate making process, it is typical to convey planographic printing plate materials held by suction cups. However, when planographic printing plate materials are conveyed while held by suction cups, problems occasionally occur in which the portions which were in contact with suction cups produce stains during printing.

Further, in an automated plate making process, it is common that planographic printing plate materials are fed to a plate making process while loaded in a cassette. In such a case, the planographic printing plate materials in a cassette are allowed to stand in an ambience of the plate making process over an extended period. As a result, problems occasionally occur in which planographic printing plate materials are subjected to variation of the imaging speed or tend to be stained during printing.

Even though the above polymerization type planographic printing plate materials are employed, drawbacks such as tendency to stain at portions contacted by suction cups or deterioration of storage stability have not been sufficiently overcome.

(Patent Document 1) JP-A No. 1-105238

(Patent Document 2) JP-A No. 2-127404

(Patent Document 3) JP-A No. 2000-98605

(Patent Document 4) JP-A No. 2001-264978

(Patent Document 5) JP-A No. 2003-295426

### SUMMARY

An object of the present invention is to provide a photosensitive planographic printing plate material, a photosensitive composition to provide the above photosensitive planographic printing plate material, and an image forming method of a planographic printing plate material, employing the above photosensitive planographic printing plate material.

Another object of the present invention is to provide a photosensitive planographic printing plate material which is suitable for exposure via a laser beam in the 350-450 nm wavelength range, which minimizes staining due to suction cup contact, and exhibits desired imaging speed, as well as ink stain resistance, a photosensitive composition to provide the above photosensitive planographic printing plate material, and an image forming method of a planographic printing plate material, employing the above photosensitive planographic printing plate material.

The above objects of the present invention are enabled by employing the following structures.

(1) A photosensitive composition comprising:

(A) an addition-polymerizable compound containing an ethylenic double bond in the molecule;

(B) an iron-arene complex which acts as a photopolymerization initiator;

(C) a polymer binder; and

(E) a siloxane glycol copolymer.

(2) The photosensitive composition of the above-described item 1,

wherein the siloxane glycol copolymer is represented by one of Formulas (1), (2), (3) and (4):
RₐSi[(OSiMe₂)ₙ(OSiMeG)_{b}OSiMe₂G]₄₋ₐ Formula (1)
RₐSi[(OSiMe₂)ₙ(OSiMeG)_{c}OSiMe₃]₄₋ₐ Formula (2)
GMe₂Si(OSiMe₂)ₙ(OSiMeG)_{b}OSiMe₂G Formula (3)
Me₃Si(OSiMe₂)ₙ(OSiMeG)_{c}OSiMe₃ Formula (4)

In Formulas (1)-(4), Rₐ represents a hydrocarbon group having 1-10 carbon atoms containing no aliphatic unsaturated group; Me represents a methyl group; G represents -D(OR¹)ₘA where D represents an alkylene group having 1-30 carbon atoms, R¹ represents an alkylene group having 2-10 carbon atoms, while m represents an integer of 1 or more, A represents a capping group; a represents an integer of 0 or 1, n represents a value of 12 or more; b represents a value of 0-50; and c represents a value of 1-50.

(3) The photosensitive composition of the above-described items 1 or 2,

further comprising (D) a dye exhibiting an absorption maximum wavelength of 350-450 nm.

(4) A photosensitive planographic printing plate material comprising a support having thereon a photosensitive layer comprising the photosensitive composition of any one of the above-described items 1-3.

(5) The photosensitive planographic printing plate material of the above-described item 4,

wherein the support is an aluminum substrate which has been subjected to alternating current surface roughening in an electrolyte comprising hydrochloric acid.

(6) An image forming method of a planographic printing plate material comprising the step of:

imagewise exposing the photosensitive planographic printing plate material of the above-described items 4 or 5 with a light source which emits a laser beam having a wavelength of 350-450 nm.

According to the present invention, it is possible to provide a photosensitive planographic printing plate material which exhibits excellent stain resistance and excellent retention properties, a photosensitive composition which provides the above photosensitive planographic printing plate material, and an image forming method of planographic printing plate material employing the above photosensitive planographic printing plate material.

Further, according to the present invention, it is possible to provide a photosensitive planographic printing plate material which is suitable for exposure via a laser beam in the 350-450 nm wavelength range, minimizes staining due to suction cup contact, and exhibits desired imaging speed and retention property of ink stain resistance, a photosensitive composition to provide the above photosensitive planographic printing plate material, and an image forming method of a planographic printing plate material, employing the above photosensitive planographic printing plate material.

### DESCRIPTION OF THE PREFERRED EMBODIMENTS

The most preferred embodiments to effect the present invention will now be described, however the present invention is not limited thereto.

The present invention is characterized in that in a photosensitive composition incorporating (A) addition polymerizable ethylenic double bond containing compound, (B) photopolymerization initiator, and (C) polymer binder, the above photosensitive composition incorporates iron arene complexes as above photopolymerization initiator (B), and further incorporates (E) siloxane glycol copolymers.

In the present invention, by specifically incorporating iron arene complexes together with siloxane glycol copolymers in a polymerizable photosensitive layer, it is possible to provide a photosensitive planographic printing plate material which minimizes staining due to suction cup contact, and exhibits desired imaging speed, as well as retention property of ink stain resistance.

The siloxane glycol copolymers according to the present invention refer to copolymers having a polysiloxane group and a polyoxyalkylene group.

Listed as examples of the siloxane glycol copolymers are EDAPLAN LA 411 and 413 (being trade names) of Munzing Chemie Co.

Listed as siloxane glycol copolymers are those which have a polysiloxane group incorporating at least 12 dimethylsiloxane bonds and have, as the polyoxyalkylene group, a polyoxyethylene group or a polyoxypropylene group.

In the present invention, commonly employed as the siloxane glycol copolymers are those represented by above Formula (1), (2), (3), or (4).

In above Formulas (1)-(4), Rₐ represents a hydrocarbon group having 1-10 carbon atoms without an aliphatic unsaturated group; Me represents a methyl group; G represents -D(OR¹)ₘA referring to a portion of a polyoxyalkylene group wherein D represents an alkylene group having 1-30 carbon atoms, R¹ represents an alkylene group having 2-10 carbon atoms, m represents a value of at least 1, and A represents a capping group; while a represents 0 or 1; b represents a value of 0-50; and c represents a value of 1-50.

Above Rₐ is a hydrocarbon group having 1-10 carbon atoms without containing an aliphatic unsaturated group, examples of which include a methyl group, an ethyl group, a propyl group, an isopropyl group, a butyl group, a hexyl group, a decyl group, a phenyl group, a tolyl group, a benzyl group, a xylyl group, a methylcylohexyl group, a cyclohexyl group, a cyclopentyl group, a β-phenylpropyl group, or a β-phenylethyl group.

D is an alkylene group having 1-30 carbon atoms, examples of which include a methylene group, an ethylene group, a propylene group, an isopropylene group, a butylene group, an octylene group, a decylene group, an octadecylene group, or myricylene group. The number of carbon atoms in D is preferably 1-16.

R¹ is an alkylene group having 2-10 carbon atoms, examples of which include an ethylene group, a propylene group, an isopropylene group, a butylene group, a hexylene group, an octylene group, or a decylene group. Of these, preferably employed is the alkylene group having 2-4 carbon atoms.

OR¹ may be any one of the oxyethylene unit, oxypropylene unit, or oxybutylene unit or combinations thereof.

“m” represents at least 1 and may be equal to or less than 1,000, but is preferably 10-100.

“A” is a capping group, while examples of terminal groups of G include a hydroxyl group (where “A” is a hydrogen atom), an ether group (where “A” is a univalent hydrocarbon group such as a methyl group, a butyl group, or a phenyl group), a carboxyl group, a salt or an ester thereof.

“n” is at least 1 or may be equal to or less than 1,500. The number of dimethylsiloxane units (OsiMe2) is preferably 10:1-50:1 with respect to G containing units, but may be at least 50:1 in the range in which the desired effects of the present invention are not adversely affected.

The content of the siloxane glycol copolymers is preferably 0.01-10% by weight with respect to the photosensitive composition, is more preferably 0.03%-5% by weight, but is most preferably 0.05-2% by weight.

((A) Polymerizable Ethylenic Double Bond Containing Compounds)

(A) Polymerizable ethylenic double bond containing compounds according to the present invention are those having an ethylenic double bond, capable of being polymerized via image exposure.

Employed as polymerizable ethylenic double bond containing compounds may be common radically polymerizable monomers, as well as multifunctional monomers or multifunctional oligomers, having a plurality of polymerizable ethylenic double bonds in the molecule, commonly employed as an ultraviolet radiation curing resin. Such compounds are not limited, and listed as preferred examples may be mono-functional acrylic acid esters of acrylate or of ε-caprolactone adducts of 2-ethylhexyl acrylate, 2-hydroxypropyl acrylate, glycerol acrylate, tetrahydrofurfuryl acrylate, phenoxyethyl acrylate, nonylphenoxyethyl acrylate, tetrahydrofurfuryloxyethyl acrylate, tetrahydrofurfuryloxyhexanolid acrylate or 1,3-dioxolane acrylate; monofunctional acrylic acid esters such as acrylates of ε-caprolactone adducts of 1,3-dioxane alcohol or 1,3-dioxolane acrylates, or methacrylic acid, itaconic acid, crotonic acid, maleic acid esters in which these acrylates are changed to methacrylate, crotonate, or maleate, such as ethylene glycol diacrylate, triethylene glycol diacrylate, pentaerythritol diacrylate, hydroquinone diacrylate, resorcinol diacrylate, hexanediol diacrylate, neopentylglycol diacrylate, tripropylene glycol diacrylate, diacrylate of hydroxypivalic acid neopentylglycol, diacrylate of neopentylglycol adipate, diacrylate of ε-caprolactone adduct of hydroxypivalic acid neopentyl glycol, ε-caprolactone adducts of 2-(2-hydroxy-1,1-dimethylethyl)-5-hydrocymethyl-5-ethyl-1,3-dioxane diacrylate, tricyclodecanedimethylol acrylate, or tricyclodecanedimethylol acrylate, bifunctional acrylic esters such as diacrylates of diglycidyl ether of 1,6-hexanediol, or methacrylic acid, itaconic acid, crotonic acid, and maleic acid esters, in which each of these acrylates are replaced with methacrylate, itaconate, crotonate, or maleate, such as s-caprolactone adducts of trimethylolpropane triacrylate, ditrimethylolpropane tetraacrylate, trimethylolethane triacrylate, pentaerythritol triacrylate, pentaerythritol tetraacrylate, dipentaerythritol tetraacrylate, dipentaerythritol pentaacrylate, dipentaerythritol hexaacrylate, or dipentaerythritol hexaacrylate; multifunctional acrylic acid ester acids such as pyrogallol triacrylate, propionic acid-dipentaerythritol triacrylate, propionic acid-dipentaerythritol tetraacrylate, or hydroxypivalylaldehyde modified dimethylolpropane triacrylate or methacrylic acid, itaconic acid, crotonic acid, or maleic esters in which each of these acrylates is replaced with methacrylate, itaconate, crotonate, or maleate.

It is also possible to employ pre-polymers in the same manner as above. Listed as the pre-polymers may be the compounds described below. Further, it is possible to appropriately employ pre-polymers which are allowed to be photopolymerizable, which are prepared in such a manner that acrylic acid or methacrylic acid is introduced into oligomers at an appropriate molecular weight. These pre-polymers may be employed individually or in combinations of at least two types, or via mixing with the above monomers and/or oligomers.

Examples of pre-polymers include polyester acrylates which are prepared in such a manner that (meth)acrylic acid is introduced into polyester which is prepared by bonding polybasic acids such as adipic acid, trimellitic acid, maleic acid, phthalic acid, terephthalic acid, humic acid, malonic acid, succinic acid, glutaric acid, itaconic acid, pyromellitic acid, fumaric acid, pimelic acid, sebacic acid, dodecanic acid, or tetrahydrophthalic acid to polyhydric alcohol such as ethylene glycol, propylene glycol, diethylene glycol, propylene oxide, 1,4-butanediol, triethylene glycol, tetraethylene glycol, polyethylene glycol, glycerin, trimethylolpropane, pentaerythritol, sorbitol, 1,6-hexanediol, or 1,2,6-hexanetriol; epoxyacrylates which are prepared by introducing (meth)acrylic acid to epoxy resins such as bisphenol A-epichlorohydrin-(meth)acrylic acid, phenol novolak-epichlorohydrin-(meth)acrylic acid; urethane acrylates which are prepared by introducing (meth)acrylic acid to urethane resins such as ethylene glycol-adipic acid-tolylenediisocyanate-2-hydroxyethyl acrylate, polyethylene glycol-trorensiisocyanate-2-hydroxyethyl acrylate, hydroxyethylphthalyl methacrylate-xylene diisocyanate, 1,2-polybutadiene glycol-tolylenediisocyanate-2-hydroxyethyl acrylate, or trimethylolpropane-propylene glycol-tolylenediisocyanate-2-hydroxyethyl acrylate; silicone resin acrylates such as polysiloxane acrylate or polysiloxane-diisocyanate-2-hydroxyethyl acrylate; alkyd modified acrylates which are prepared by introducing a (meth)acryloyl group to oil modified alkyd resins; and spirane resin acrylates.

The photosensitive composition according to the present invention is capable of incorporating monomers such as phosphazene monomers, triethylene glycol, isocyanuric acid EO (ethylene oxide) modified diacrylate, isocyanuric acid EO modified triacrylate, dimethyloltricyclodecane diacrylate, trimethylolpropane acrylic acid benzoic acid ester, alkylene glycol type modified acrylic acid, or urethane modified acrylate, as well as addition-polymerizable oligomers and pre-polymers having constituting units formed of the above polymers.

Further listed as ethylenic double bond containing compounds capable of being simultaneously employed are phosphoric acid ester compounds having at least one (meth)acryloyl group. The above compounds are those in which at least one of the hydroxyl groups of phosphoric acid undergoes esterification.

Listed as others may be the compounds described in JP-A Nos. 58-212994, 61-6649, 62-46688, 62-48589, 62-173295, 62-187092, 63-67189, and 1-244891. Further, in the present invention, appropriately employed may be the compounds described on pages 286-294 of “11290 no Kagaku Shohin (11290 Chemical Products)”, Kagakukogyo Nippo-sha, and on pages 11-65 of “UV•EB Handbook (Genryo Hen, (Raw Material Part)), Kobunshi Kankokai. Of these, the compounds having at least two acryl or methacryl groups are preferred in the present invention, and further, those exhibiting a molecular weight of at most 10,000 but preferably at most 5,000 are preferred.

Further, it is preferable to employ, in the photosensitive composition according to the present invention, polymerizable ethylenic double bond containing compounds having a tertiary amino group in the molecule. Though the structures are not particularly limited, preferably employed are those which are prepared by modifying tertiary amine compounds having a hydroxyl group employing glycidyl methacrylate, methacrylic acid chloride, or acrylic acid chloride. Specifically preferably employed are polymerizable compounds described in JP-A Nos. 1-165613, 1-203413, and 1-197213.

Further in the present invention, it is preferable to employ the reaction products of polyhydric alcohols having a tertiary amino group in the molecule, being tertiary amine monomers, diisocyanate compounds, and compounds having a hydroxyl group as well as an addition-polymerizable ethylenic double bond in the molecule.

Polyhydric alcohols having a tertiary amino group in the molecule, as described herein, include, but are not limited to, triethanolamine, N-methyldiethanolamine, N-ethyldiethanolamine, N-n-butyldiethanolamine, N-tert.-butyldiethanolamine, N,N-di(hydroxyethyl)aniline, N,N,N′,N′-tetra-2-hydroxypropylethylenediamine, p-tolyldiethanolamine, N,N,N′,N′-tetra-2-hydroxyethylethylenediamine, N,N-bis(2-hydroxypropyl)aniline, allyldiethanolamine, 3-(dimethylamino)-1,2-propanediol, 3-diethylamino-1,2-propanediol, N,N-di(n-propyl)amino-2,3-propanediol, N,N-di(iso-propyl)amino-2,3-propanediol, and 3-(N-methyl-N-benzylamino)-1,2-propanediol.

Diisocyanate compounds include, but are not limited to, butane-1,4-diisocyanate, hexane-1,6-diisocyanate, 2-methylpentane-1,5-diisocyanate, octane-1,8-diisocyanate, 1,3-diisocyanatomethyl-cyclohexane, 2,2,4-trimethylhexane-1,6-diisocyanate, isoholondiisocyante, 1,2-phenylene diisocyanate, 1,3-phenylene diisocyanate, 1,4-phenylene diisocyanate, trilene-2,4-diisocyanate, trilene-2,5-diisocyanate, trilene-2,6-diisocyanate, 1,3-di(isocyanatomethyl)benzene, and 1,3-bis(1-isocyanato-1-methylethyl)benzene.

Examples of compounds, having a hydroxyl group and an addition-polymerizable ethylenic double bond in the molecule, include 2-hydroxyethyl methacrylate, 2-hyroxyethyl acrylate, 4-hydroxybutyl acrylate, 2-hydroxypropylene-1,3-dimethacrylate, and 2-hydroxypropylemne-1-methacrylate-3-acrylate.

These reactions are common for diol compounds, diisocyanate compounds, or hydroxyl group containing acrylate compounds, and may be performed in the same manner as the method to synthesize urethane acrylates.

Further listed below are specific examples of reaction products of polyhydric alcohols having a tertiary amine group in their structure, diisocyanate compounds, and compounds having a hydroxyl group and a addition-polymerizable ethylenic double bond in their structure.
M-1: reaction product of triethanolamine (1 mol), hexane-1,6-diisocyanate (3 mol), and 2-hydroxyethyl methacrylate (3 mol)
M-2: reaction product of triethanolamine (1 mol), isophoronediisocyanate (3 mol), and 2-hydroxyethyl acrylate (3 mol)
M-3: reaction product of N-n-butyldiethanolamine (1 mol), 1,3-bis(1-isocyanato-1-methyethylbenzene (2 mol), and 2-hydroxypropylene-1-metahcrylate-3-acrylate (2 mol)
M-4: reaction product of N-n-butylethanolamine (1 mol), 1,3-di(isocyanatomethyl)benzene (2 mol), and 2hydroxypropylene-1-methacrylate-3-acrylate (2 mol)
M-5: reaction product of N-methyldiethanolamine (1 mol), trilene-2,4-diisocyanate (2 mol), and 2-hydroxypropylene-1,3-dimethacrylate (2 mol)

In addition, it is possible to employ the acrylates or alkyl acrylates described in JP-A Nos. 1-105238 and 2-127404.

The content of polymerizable ethylenic unsaturated bond containing compounds is preferably 20-80% by weight with respect to the photosensitive composition, is more preferably 30-70% by weight, but is most preferably 40-60% by weight.

((B) Photopolymerization Initiator)

Photopolymerization initiators according to the present invention are compounds capable of initiating polymerization of polymerizable ethylenic unsaturated bond containing compounds during image exposure.

The photosensitive compositions according to the present invention are required to incorporate iron arene complex compounds as a photopolymerization initiator.

<Iron Arene Complex Compounds>

Iron arene complex compounds according to the present invention are those represented by following Formula (a).
[A-Fe—B]⁺X⁻ Formula (a)
wherein A represents an unsubstituted cyclopentadienyl group or cyclohexadienyl group, and B represents a compound having an aromatic ring, while X⁻ represent an anion.

Specific examples of compounds having an aromatic ring include benzene, toluene, xylene, cumene, naphthalene, 1-methylnaphthalene, 2-methylnaphthalene, biphenyl, fluorene, anthracene, and pyrene, while specific examples of X⁻ include PF₆⁻, BF₄⁻, SbF₆⁻, AlF₄⁻, and CF₃SO₃⁻. Listed as substituents of a substituted cyclopentadienyl or cyclohexadienyl group are an alkyl group such as a methyl or ethyl group, a cyano group, an acetyl group, and a halogen atom.

The content ratio of the iron arene complex compounds is preferably 0.1-20% by weight with respect to the polymerizable group containing compounds, but is more preferably 0.1-10% by weight.

Listed below are specific examples of the above iron arene complex compounds.
Fe-1: (η6-benzene)(η5-cyclopentadienyl)iron(2) hexafluorophosphate
Fe-2: (η6-toluene)(η5-cyclopentadienyl)iron(2) hexafluorophosphate
Fe-3: (η6-cumene)(η5-cyclopentadienyl)iron(2) hexafluorophosphate
Fe-4: (η6-benzene)(η5-cyclopentadienyl)iron(2) hexafluoroarsenate
Fe-5: (η6-benzene)(η5-cyclopentadienyl)iron(2) tetrafluoroborate
Fe-6: (η6-naphthalene)(η5-cyclopentadienyl)iron(2) hexafluorophosphate
Fe-7: (η6-anthracene)(η5-cyclopentadienyl)iron(2) hexafluorophosphate
Fe-8: (η6-pyrene)(η5-cyclopentadienyl)iron(2) hexafluorophosphate
Fe-9: (η6-benzene)(η5-cyanocyclopentadienyl)iron(2) hexafluorophosphate
Fe-10: (η6-toluene)(η5-acetylcyclopentadienyl)iron(2) hexafluorophosphate
Fe-11: (η6-cumene)(η5-cyclopentadienyl)iron(2) tetrafluoroborate
Fe-12: (η6-pyrene)(η5-carboethoxycyclohexadienyl)iron(2) hexafluorophosphate
Fe-13: (η6-benzene)(η5-1,3-dichlorocyclohexadienyl)iron(2) hexafluorophosphate
Fe-14: (η6-pyrene)(η5-cyclohexadienyl)iron(2) hexafluorophosphate
Fe-15: (η6-acetophenone)(η5-cyclohexadienyl)iron(2) hexafluorophosphate
Fe-16: (η6-methyl benzoate)(η5-cyclopentadienyl)iron(2) hexafluorophosphate
Fe-17: (η6-benzenesulfoamido)(η5-cyclopentadienyl)iron(2) terafluoroborate
Fe-18: (η6-benzamido)(η5-cyclopentadienyl)iron(2) hexafluorophosphate
Fe-19: (η6-cyanobenzene)(η5-cyanocyclopentadienyl)iron(2) hexafluorophosphate
Fe-20: (η6-chloronaphthalene)(η5-cyclopentadienyl)iron(2) hexafluorophosphate
Fe-21: (η6-anthracene)(η5-cyanocyclopentadienyl)iron(2) hexafluorophosphate
Fe-22: (η6-chlorobenzene)(η5-cyclopentadienyl)iron(2) hexafluorophosphate
Fe-23: (η6-chlorobenzene)(η5-cyclopentadienyl)iron(2) tetrafluoroborate

It is possible to synthesize these compounds based on the method described in Dokl. Akd. Nauk SSSR 149 615 (1963).

The content of the iron arene complex compounds according to the present invention is preferably 0.1-10% by weight with respect to the photosensitive composition, is more preferably 1.0-5.0% by weight, but is most preferably 2.0-4.0% by weight.

Further, the content of the iron arene complex compounds is preferably 0.1-30% by weight with respect to above (A) ethylenic unsaturated bond containing compound, is more preferably 0.5-20% by weight, but is most preferably 1.0-10% by weight.

The weight ratio (iron arene complex compounds/siloxane glycol copolymers) of the iron arene complex compounds according to the present invention to the siloxane glycol copolymers is preferably 5-100, but is most preferably 10-50.

Other than the iron arene complexes, incorporated may be, as a photopolymerization initiator, the following compounds. The content of these other initiators is preferably 0-5% by weight with respect to the photosensitive composition, but is most preferably 0-3% by weight.

Preferably employed as other photopolymerization initiators are, for example, biimidazole compounds, titanocene compounds, polyhalogen compounds, monoalkyltriaryl borate compounds.

(Biimidazole Compounds)

Biimidazole compounds are derivatives of biimidazole and include those described in JP-A No. 2003-295426.

Preferably employed as biimidazole compounds are hexaarylbiimidazole (HABI, triarylimidazole dimer) compounds.

The production process of HABIs is described in DE No. 1,470,154, while use of these in a photopolymerizable composition is described in EP Nos. 24,629, and 107,792, U.S. Pat. No. 4,410,629, EP No. 215,453, and De No. 3,211,312.

Examples of preferable derivatives include 2,4,5,2′,4′,5′-hexaphenylbiimidazole, 2,2′-bis(2-chlorophenyl)-4,5,4′,5′-tetraphenylbiimidazole, 2,2′-bis(2-bromophenyl)-4,5,4′,5′-tetraphenylbiimidazole, 2,2′-bis(2,4-dichlorophenyl)-4,5,4′,5′-tetraphenylbiimidazole, 2,2′-bis(2-chlorophenyl)-4,5,4′,5′-tetrakis(3-methoxyphenyl)biimidazole, 2,2′-bis(2-chlorophenyl)-4,5,4′,5′-tetrakis(3,4,5-trimethoxyphenyl)-biimidazole, 2,5,2′,5′-tetrakis(2-chlorophenyl)-4,4′-bis(3,4-dimethoxyphenyl)biimidazole, 2,2′-bis(2,6-dichlorophenyl)-4,4,4′,5′-tetraphenylbiimidazole, 2,2′-bis(2-nitrophenol)-4,5,4′,5′-tetraphenylbiimidazole, 2,2′-di-o-tolyl-4,5,4′,5′-tetraphenylbiimidazole, 2,2′-bis(2-ethoxyphenyl)-4,5,4′,5′-tetraphenylbiimidazole, and 2,2-bis82,6-difluorophenyl)-4,5,4′,5′-tetraphenylbiimidzole.

The amount of HABI is typically in the range of 0.01-30% by weight with respect to the total weight of the non-volatile component of the photosensitive composition, but is preferably in the range of 0.5-20% by weight.

Titanocene compounds include those described in JP-A No. 63-41483 and JP-A No. 2-291. Further preferable specific examples include bis(cyclopentadienyl)-Ti-di-chloride, bis(cyclopentadienyl)-Ti-bis-phenyl, bis(cyclopentadienyl)-Ti-bis-2,3,4,5,6-pentafluorophenyl, bis(cyclopentadienyl)-Ti-bis-2,3,5,6-tetrafluorophenyl, bis(cyclopentadienyl)-Ti-bis-2,4,6-trifluorophenyl, bis(cyclopentadienyl)-Ti-bis-2,6-difluorophenyl, bis(cyclopentadienyl)-Ti-bis-2,4-difluorophenyl, bis(methylcyclopentadienyl)-Ti-bis-2,3,4,5,6-pentafluorophenyl, bis(methylcyclopentadienyl)-Ti-bis-2,3,5,6-tetrafluorophenyl, bis(methylcyclopentadienyl)-Ti-bis-2,6-difluorophenyl (IRUGACURE 727L, produced by Ciba Specialty Chemicals Co.), bis(cyclopentadienyl)-bis(2,6-difluoro-3-pyri-1-yl)phenyl)titanium (IRUGACURE 784, produced by Ciba Specialty Chemicals Co.), bis(cyclopentadienyl)-bis(2,4,6-trifluoro-3-(pyri-1-yl)phenyl)titanium, and bis(cyclopentadienyl)-bis(2,4,6-trifluoro-3-(2-5-dimthylpyri-1-yl)phenyl)titanium.

Polyhalogen compounds are those which have a trihalogenmethyl group, a dihalogenmethyl group, or a halogenmethyl group. Particularly preferably employed are the halogen compounds represented by following Formula (a) and the compounds in which the above group is substituted for an oxadiazole ring. Of these, particularly preferably employed are the halogen compounds represented by following Formula (b).
R¹—CY₂—(C═O)—R² Formula (a)
wherein R¹ represents a hydrogen atom, a halogen atom, an alkyl group, an aryl group, an acyl group, an alkylsulfonyl group, an arylsulfonyl group, an iminosulfonyl group, or a cyano group; R² represents a univalent substituent; R¹ and R² may be joined together to form a ring; and Y represents a halogen atom.
CY₃—(C═O)—X—R³ Formula (b)
wherein R³ represents a univalent substituent; X represents —O— or —NR⁴— where R⁴ represents a hydrogen atom or an alkyl group; when X is —NR⁴—, R³ and R⁴ may be joined together to form a ring; and Y represents a halogen atom. Of these, particularly preferably employed are those having a polyhalogen acetylamide group.

Further preferably employed are compounds in which a polyhalogen methyl group is substituted for an oxadiazole ring.

Listed as monoalkyltriaryl borate compounds are those described in JP-A Nos. 62-150242 and 62-143044. More preferred specific examples include tetra-n-butyl ammonium-n-butyltrinaphthalene-1-yl-borate, tetra-n-butyl ammonium-n-butyl-triphenyl-borate, tetra-n-butyl ammonium-n-butyl-tri-(4-tert-butylphenyl)-borate, tetra-n-butyl ammonium-n-hexyl-tri-(3-chloro-4-methylphenyl)-borate, and tetra-n-butyl ammonium-n-hexyl-tri-(3-fluorophenyl)-borate.

In the present invention, simultaneously employed as a photopolymerization initiator may be others known as a photopolymerization initiator.

((C) Polymer Binder)

Polymer binders will now be described.

Employed as the polymer binders used in the present invention may be acryl based polymers, polyvinyl butyral resins, polyurethane resins, polyamide resins, polyester resins, epoxy resins, phenol resins, polycarbonate resins, and polyvinyl formal resins, as well as shellac and other natural resins. These may be employed in combinations of at least two types.

Of these, preferred are vinyl based copolymers produced by copolymerizing acryl based monomers. Further, it is preferable that the polymer binders are copolymers composed of (a) monomers having a carboxyl group and (b) alkyl methacrylates or alkyl acrylates.

Preferred specific example of monomers having a carboxyl group include α, β-unsaturated carboxylic acids such as acrylic acid, methacrylic acid, maleic acid, maleic anhydride, itaconic acid, and itaconic anhydride. In addition, also preferred are carboxylic acids such as a halfester of phthalic acid and 2-hydroxymethacrylate.

Specific examples of alkyl methacrylates and alkyl acylates include unsubstituted alkyl esters such as methyl methacrylate, ethyl methacrylate, propyl methacrylate, butyl methacrylate, amyl methacrylate, hexyl methacrylate, heptyl methacrylate, octyl methacrylate, nonyl methacrylate, decyl methacrylate, undecyl methacrylate, dodecyl methacrylate, methyl acrylate, ethyl acrylate, propyl acrylate, butyl acrylate, amyl acrylate, hexyl acrylate, heptyl acrylate, octyl acrylate, nonyl acrylate, decyl acrylate, undecyl acrylate, or dodecyl acrylate; cyclic alkyl esters such as cyclohexyl methacrylate or cyclohexyl acrylate; and substituted alkyl esters such as benzyl methacrylate, 2-chloroethyl methacrylate, N,N-dimethylaminoethyl methacrylate, glycidyl methacrylate, benzyl acrylate, 2-chloroethyl acrylate, N,N-dimethylaminoethyl acrylate, or glycidyl acrylate.

Further, in the polymer binders of the present invention, employed as other copolymerization monomers may be those described in following (1)-(14).

1) Monomers having an aromatic hydroxyl group, such as o- (or p- or m-) hydroxystyrene or o- (or p- or m-) hydroxyphenyl acrylate

2) Monomers having an aliphatic hydroxyl group, such as 2-hydroxyethyl acrylate, 2-hydroxyethyl methacrylate, N-methylolacrylamide, 4-hydroxybutyl methacrylate, 5-hydroxypentyl acrylate, 5-hydroxypentyl methacrylate, 6-hydroxythexyl acrylate, 6-hydroxyhexyl methacrylate, N-(2-hydroxyethyl)acrylamide, N-(2-hydroxyethyl)methacrylamide, or hydroxyethyl vinyl ether

3) Monomers having an aminosulfonyl group, such as m- (or p-) aminosulfonylphenyl methacrylate, m- (or p-) aminosulfonylphenyl acrylate, N-(p-aminosulfonylphenyl)methacrylamide, or N-(p-aminosulfonylphenyl)acrylamide

4) Monomers having a sulfonamide group, such as (p-toluenesulfonyl)acrylamide or N-(p-toluenesulfonyl)methacrylamide

5) Acrylamides or methacrylamides, such as acrylamide, methacrylamide, N-ethylacrylamide, N-hexylacrylamide, N-cyclohexylacrylamide, N-phenylacrylamide, N-(4-nitrophenyl)acrylamide, N-ethyl-N-phenylacrylamide, N-(4-hyroxyphenyl)acrylamide, or N-(4-hydroxyphenyl)methacrylamide

6) Monomers having a fluorinated alkyl group, such as trifluoroethyl acrylate, trifluoroethyl methacrylate, tetrafluoropropyl methacrylate, hexafluoropropyl methacrylate, octafluoropentyl acrylate, octafluoropentyl methacrylate, heptadecafluorodecyl methacrylate, or N-butyl-N-(2-acryloxyethyl)heptadecafluorooctylsufonamide

7) Vinyl ethers, such as ethyl vinyl ether, 2-chloroethyl vinyl ether, propyl vinyl ether, butyl vinyl ether, octyl vinyl ether, or phenyl vinyl ether

8) Vinyl esters, such as vinyl acetate, vinyl chloroacetate, vinyl butyrate, or vinyl benzoate

9) Styrenes such as styrene, methylstyrene, or chloromethylstyrene

10) Vinyl ketones, such as methyl vinyl ketone, ethyl vinyl ketone, propyl vinyl ketone, or phenyl vinyl ketone

11) Olefins, such as ethylene, propylene, i-butylene, or isoprene

12) N-vinylpyrrolidone, N-vinylcarbazole, or 4-vinylpyridine

13) Monomers having a cyano group, such as acrylonitrile, methacrylonitrile, 2-pentenenitrile, 2-methyl-3-butenenitrile, 2-cyanoethyl acrylate, or o- ) or m- or p-) cyanostyrene, and

14) Monomers having an amino group, such as N,N-diethylaminoethyl methacrylate, N,N-dimethylaminoethyl acrylate, N,N-dimethylaminoethyl methacrylate, polybutadieneurethane acrylate, N,N-dimethylaminopropylacrylamide, N,N-dimethylaminopropylacrylamide, N,N-dimethylacrylamide, acryloylmorpholine, N-i-propylacrylamide, or N,N-diethylacrylamide.

Further, other monomers capable of copolymerizing with these monomers may be copolymerized.

Further, the polymer binders used in the present invention are preferably vinyl based polymers having a carboxyl group on the side chain and a polymerizable double bond. It is possible to produce such binders in such a manner that a carboxyl group in the molecule of the above vinyl based copolymers undergoes addition reaction with compounds having, in the molecule, a (meth)acryloyl group and an epoxy group. Unsaturated bond containing vinyl based copolymers are also preferred as a polymer binder.

Specific examples of compounds having, in the molecule, both an unsaturated bond and an epoxy group include glycidyl acrylate and glycidyl methacrylate, as well as epoxy group containing unsaturated compounds described in JP-A No. 11-271969. Further, it is possible to produce the above compounds in such a manner that the hydroxyl group in the molecule of the above vinyl based polymers undergoes addition reaction with compounds having, in the molecule, a (meth)acryloyl group and an isocyanate group. Unsaturated bond containing vinyl based copolymers are also preferred as a polymer binder. Preferably listed as compounds having, in the molecule, both an unsaturated bond and an isocyanate group are vinyl isocyanate, (meth)acryl isocyanate, 2-(meth)acryloyloxyethyl isocyanate, and m- or p-isopropenyl-α,α′-dimethylbenzyl isocyanate, while listed are (meth)acryl isocyanate and 2-(meth)acryloyloxyethyl isocyanate.

It is possible to perform addition reaction of compounds having, in the molecule, a (meth)acryloyl group and an epoxy group to the carboxyl group in the molecule of vinyl based copolymers, employing methods known in the art. It is possible to perform reaction at a reaction temperature of 20-100° C., preferably 40-80° C., but most preferably at lower than or equal (during refluxing) to the boiling point of used solvents, over a reaction time of 2-10 hours but preferably 3-6 hours. Listed as employed solvents are those which are employed in the polymerization reaction of the above vinyl based polymers. Further, after the polymerization reaction, solvents are not removed but are further usable in the introduction reaction of alicyclic epoxy group containing unsaturated compounds. Further, if required, the reaction may be performed in the presence of catalysts and polymerization inhibitors.

Preferred as such catalysts are amine based or ammonium chloride based compounds. Specific amine based compounds include triethylamine, tributylamine, dimethylaminoethanol, diethylaminoethanol, methylamine, ethylamine, n-propylamine, isopropylamine, 3-methoxypropylamine, butylamine, allylamine, hexylamine, 2-ethylhexylamine, and benzylamime, while the ammonium chloride based compound includes triethylbenzylammonium chloride.

When these are employed as a catalyst, the added amount is in the range of 0.01-20.0% by weight with respect to the employed unsaturated compounds having an alicyclic epoxy group. Further, listed as polymerization inhibitors are hydroquinone, hydroquinone monomethyl ether, tert-butylhydroquinone, 2,5-di-tert-butylhydroquinone, methylhydroquinone, p-benzoquinone, methyl-p-benzoquinone, tert-butyl-p-benzoquinone, and 2,5-diphenyl-p-benzoquinone. The employed amount is 0.01-5.0% by weight with respect to the employed unsaturated compounds having an alicyclic epoxy group. Progress of the reaction is monitored via the acid value of the reaction system, and when the acid value reaches 0, the reaction is terminated.

It is possible to perform addition reaction of compounds, having in the molecule, a (meth)acryloyl group and an isocyanate group, to a hydroxyl group in the molecule of a vinyl based polymer, employing methods known in the art. It is possible to perform reaction at a reaction temperature of 20-100° C., preferably 40-80° C., but most preferably at lower than or equal to (during refluxing) the boiling point of used solvents, for a reaction time of 2-10 hours but preferably 3-6 hours. Listed as employed solvents are those which are employed in the polymerization reaction of the above copolymers. Further, after the polymerization reaction, solvents are not removed but are usable in the introduction reaction of an unsaturated compound containing an isocyanate group. Further, if required, the reaction may be performed in the presence of catalysts and polymerization inhibitors. Herein, preferred as such catalysts are tin based or amine based compounds, specific examples of which include dibutyl tin laurate and triethylamine.

The added amount of catalysts is preferably in the range of 0.01-20.0% by weight with respect to the employed compounds having a double bond. Further, listed as polymerization inhibitors are hydroquinone, hydroquinone monomethyl ether, tert-butylhydroquinone, 2,5-di-tert-butylhydroquinone, methylhydroquinone, p-benzoquinone, methyl-p-benzoquinone, and tert-butyl-p-benzoquinone. The used amount is typically 0.01-5.0% by weight with respect to the employed unsaturated compounds having an isocyanate group. The progress of the reaction is monitored via inspecting the presence of the isocyanate group in the reaction system, based on the infrared absorption spectra (IR), and if no absorption is noticed, the reaction may be terminated.

The amount of the vinyl based polymers having a carboxyl group and a polymerizable double bond on the side chain is preferably 50-100% by weight with respect to the total polymer binders, but is more preferably 100% by weight.

The content of polymer binders in the photosensitive composition is preferably in the range of 10-90% by weight, is more preferably in the range of 15-70% by weight, but is most preferably in the range of 20-50% by weight in view of the photographic speed.

(Dyes Exhibiting the Maximum Absorption 350-450 nm Wavelength)

It is preferable that the photosensitive composition of the present invention incorporates sensitizing dyes exhibiting a maximum absorption wavelength 230-450 nm.

Examples of such dyes include cyanine, merocyanine, porphyrin, spiro compounds, ferrocene, fluorene, fulgide, imidazole, perylene, phenazine, phenothiazine, acridine, azo compounds, diphenylmethane, triphenylmethane, triphenylamine, coumarin derivatives, quinacridone, indigo, styryl, pyrylium compounds, pyrromethene compounds, pyrazolotriazole compounds, benzothiazole compounds, barbituric acid derivatives, thiobarbituric acid derivatives, and keto alcohol borate complexes.

Of such sensitizing dyes, preferably employed are the coumarin based dyes represented by following Formula (A).

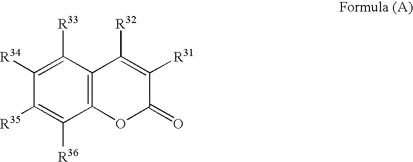

In the above formula, R³¹-R³⁶ each represents a hydrogen atom or a substituent. Listed as such substituents are an alkyl group (for example, a methyl group, an ethyl group, a propyl group, an isopropyl group, a tert-butyl group, a pentyl group, a hexyl group, an octyl gropup, a dodecyl group, a tridecyl group, a tetradecyl group, or a pentadecyl gropup); a cycloalkyl gropup (for example, a cyclopentyl group or a cyclohexyl group); an alkenyl group (for example, an vinyl group or an allyl group); an alkynyl group (for example, an ethynyl group or a propagyl group); an aryl gropup (for example, a phenyl group or a naphthyl group); a heteroaryl group (for example, a furyl group, a thienyl group, a pyridyl gropup, a pyridazyl group, a pyrimidyl group, a pyrazyl group, a triazyl group, an imidazolyl group, a pyrazolyl group, a thiazolyl group, a benzimidazolyl group, a benzoxazolyl group, a quinazoyl group, or a phthalazyl group); a heterocycyl group (for example, a pyrrolidyl group, an imidazolydyl group, a morpholyl group, or an oxazolydyl group); an alkoxy group (for example, a methoxy group, an ethoxy group, a propyloxy group, a pentyloxy group, a hexyloxy group, an octyloxy group, or a dodecyloxy group); a cycloalkoxy group (for example, a cyclopentyloxy group or a cyclohexyloxy group); an aryloxy group (for example, a phenoxy group or a naphthyloxy group); an alkylthio group (for example, a methylthio group, an ethylthio group, a propylthio group, a pentylthio group, a hexylthio group, an octylthio group, or a dodecylthio group); a cycloalkylthio group (for example, a cyclopentylthio group or a cyclohexylthio group); an arylthio group (for example, a phenylthio group or a naphthylthio group); an alkoxycarbonyl group (for example, a methoxycarbonyl group, an ethyloxycarbonyl group, a butyloxycarbonyl group, an octyloxycarbonyl group, or a dodecyloxycarbonyl group); an aryloxycarbonyl group (for example, a phenyloxycarbonyl group, or a naphthyloxycarbonyl group); a sulfamoyl group (for example, an aminosulfonyl group, a methylaminosulfonyl group, a dimethylaminosulfonyl group, a butylaminosulfonyl group, a hexylaminosulfonyl group, a cyclohexylaminosulfonyl group, an octylaminosulfonyl group, a dodecylaminosulfonyl group, a phenylaminosulfonyl group, a naphthylaminosulfonyl group, or a 2-pyridylaminosulfonyl group); an acyl group (for example, an acetyl group, an ethylcarbonyl group, a propylcarbonyl group, a pentylcarbonyl group, a cyclohexylcarbonyl group, an octylcarbonyl group, a 2-ethylhexylcarbonyl group, a dodecylcarbonyl group, a phenylcarbonyl group, a naphthylcarbonyl group, or a pyridylcarbonyl group); an acyloxy group (for example, an acetyloxy group, an ethylcarbonyloxy group, a butylcarbonyloxy group, an octylcarbonyloxy group, a dodecylcarbonyloxy group, or a phenylcarbonyloxy group); an amido group (for example, a methylcarbonylamino group, an ethylcarbonylamino group, a dimethylcarbonylamino group, a propylcarbonylamino gropup, a pentylcarbonylamino group, a cyclohexylcarbonylamino group, a 2-ethylhexylcarbonylamino group, an octylcarbonylamino group, a dodecylcarbonylamino group, a phenylcarbonylamino gropup, or a naphthylcarbonylamino group); a carbamoyl group (for example, an aminocarbonyl group, a methylaminocarbonyl group, a dimethylaminocarbonyl group, a propylaminocarbonyl group, a pentylaminocarbonyl group, a cyclohexylaminocarbonyl group, an octylaminocarbonyl group, a 2-ethylhexylaminocarbonyl group, a dodecylaminocarbonyl group, a phenylaminocarbonyl group, a naphthylaminocarbonyl group, or a 2-pyridylaminocarbonyl group); a ureido group (for example, a methylureido group, an ethylureido group, a pentylureido group, a cyclohexylureido group, an octylureido group, a dodecylureido group, a phenylureido group, a naphthylureido group, or a 2-pyridylaminoureido group); a sulfinyl group (for example, a methylsulfinyl group, an ethylsulfinyl group, a butylsulfinyl group, a cyclohexylsulfinyl group, a 2-ethylhexylsulfinyl group, a dodecylsulfinyl group, a phenylsulfinyl group, a naphthylsulfinyl group, or a 2-pyridylsulfinyl group); an alkylsulfonyl group (for example, a methylsulfonyl group, an ethylsulfonyl group, a butylsulfinyl group, a cyclohexylsulfonyl group, a 2-ethylhexylsulfonyl group, or a dodecylsulfonyl group); an arylsulfonyl group (a phenylsulfonyl group, a naphthylsulfonyl group, or a 2-pyridylsulfonyl group); an amino group (for example, an amino group, an ethylamino group, a dimethylamino group, a butylamino group, a cyclopentylamino group, a 2-ethylhexylamino group, a dodecylamino group, an anilino group, a naphthylamino group, or a 2-pyridylamino group); and a halogen atom (for example, a fluorine atom, a chlorine atom, or a bromine atom); as well as a cyano group, a nitro group, and a hydroxyl group. These substituents may be substituted with the above substituents. Further, a plurality of substituents may be joined to form a ring.

Of these, most preferred is coumarin in which R³⁵ is an amino group, an alkylamino group, a dialkylamino group, an arylamino group, or an alkylamino group. In such a case, it is possible to preferably employ one in which an alkyl group substituted for the amino group forms a ring with substituents of R³⁴ and R³⁵.

Further, it is more preferable that either or both R³¹ and R³² each represents an alkyl group (for example, a methyl group, an ethyl group, a propyl group, an isopropyl group, a tert-butyl group, a pentyl group, a hexyl group, an octyl gropup, a dodecyl group, a tridecyl group, a tetradecyl group, or a pentadecyl gropup); a cycloalkyl gropup (for example, a cyclopentyl group or a cyclohexyl group); an alkenyl group (for example, a vinyl group or an allyl group); an aryl gropup (for example, a phenyl group or a naphthyl group); a heteroaryl group (for example, a furyl group, a thienyl group, a pyridyl group, a pyridazyl group, a pyrimidyl group, a pyrazyl group, a triazyl group, an imidazolyl group, a pyrazolyl group, a thiazolyl group, a benzimidazolyl group, a benzoxazolyl group, a quinazoyl group, or a phthalazyl group); a heterocyclyl group (for example, a pyrrolidyl group, an imidazolydyl group, a morpholyl group, or an oxazolydyl group); an alkoxycarbonyl group (for example, a methyloxycarbonyl group, an ethyloxycarbonyl group, a butyloxycarbonyl group, an octyloxycarbonyl group, or a dodecyloxycarbonyl group); an aryloxycarbonyl group (for example, a phenyloxycarbonyl group, or a naphthyloxycarbonyl group); an acyl group (for example, an acetyl group, an ethylcarbonyl group, a propylcarbonyl group, a pentylcarbonyl group, a cyclohexylcarbonyl group, an octylcarbonyl group, a 2-ethylhexylcarbonyl group, a dodecylcarbonyl group, a phenylcarbonyl group, a naphthylcarbonyl group, or a pyridylcarbonyl group); an acyloxy group (for example, an acetyloxy group, an ethylcarbonyloxy group, a butylcarbonyloxy group, an octylcarbonyloxy group, a dodecylcarbonyloxy group, or a phenylcarbonyloxy group); a carbamoyl group (for example, an aminocarbonyl group, a methylaminocarbonyl group, a dimethylaminocarbonyl group, a propylaminocarbonyl group, a pentylaminocarbonyl group, a cyclohexylaminocarbonyl group, an octylaminocarbonyl group, a 2-ethylhexylaminocarbonyl group, a dodecylaminocarbonyl group, a phenylaminocarbonyl group, a naphthylaminocarbonyl group, or a 2-pyridylaminocarbonyl group); a sulfinyl group (for example, a methylsulfinyl group, an ethylsulfinyl group, a butylsulfinyl group, a cyclohexylsulfinyl group, a 2-ethylhexylsulfinyl group, a dodecylsulfinyl group, a phenylsulfinyl group, a naphthylsulfinyl group, or a 2-pyridylsulfinyl group); an alkylsulfonyl group (for example, a methylsulfonyl group, an ethylsulfonyl group, a butylsulfinyl group, a cyclohexylsulfonyl group, a 2-ethylhexylsulfonyl group, or a dodecylsulfonyl group); an arylsulfonyl group (a phenylsulfonyl group, a naphthylsulfonyl group, or a 2-pyridylsulfonyl group); a halogen atom (for example, a fluorine atom, a chlorine atom, or a bromine atom); as well as a cyano group, a nitro group, and a halogenated alkyl group (for example, a trifluoromethyl group, a tribromomethyl group, or a trichloromethyl group.

Preferred specific examples include, but are not limited to, the compounds listed below.

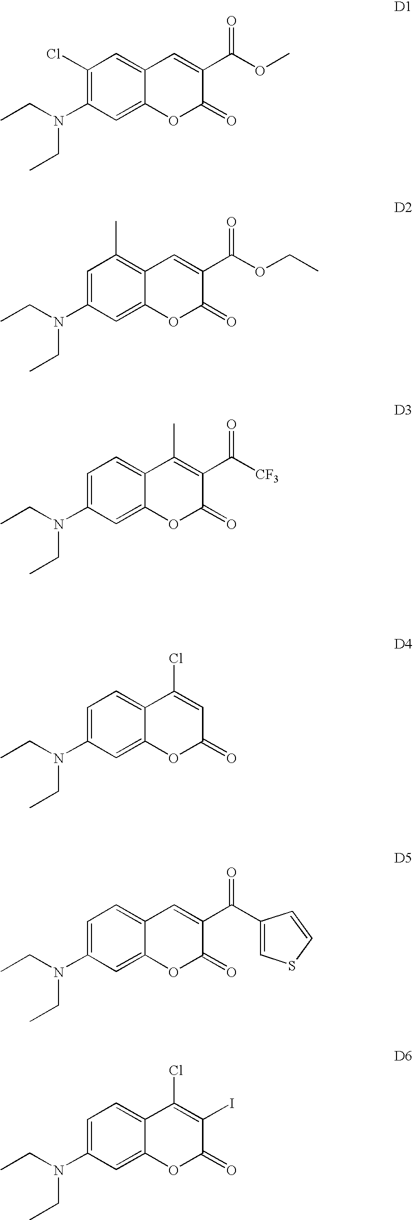

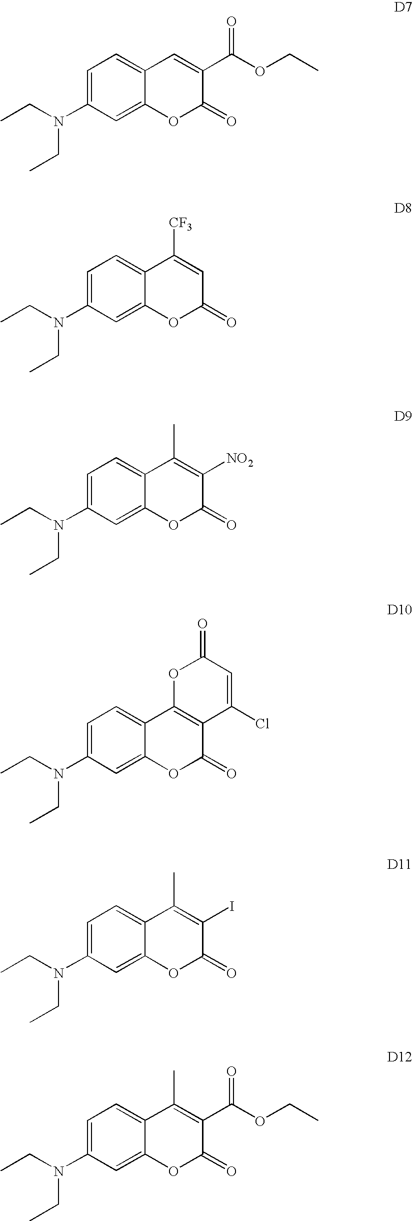

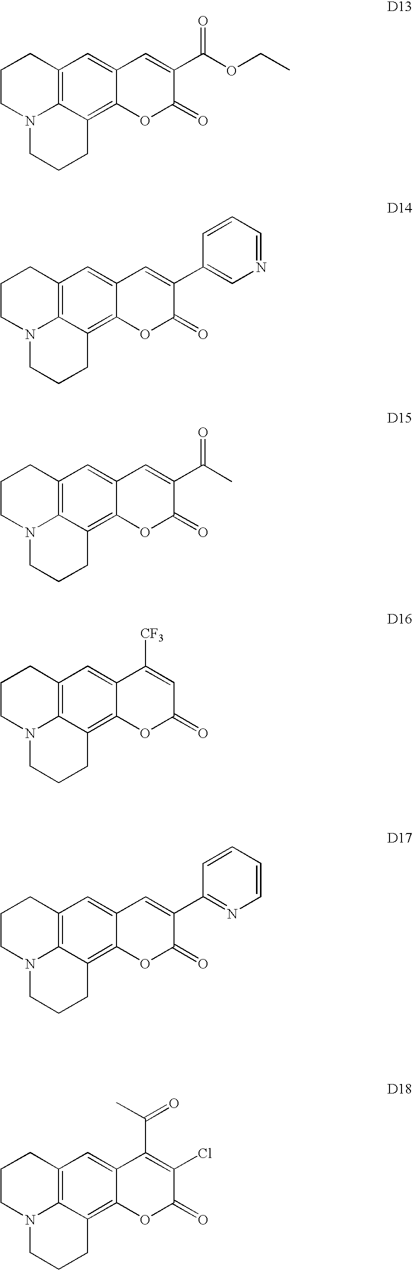

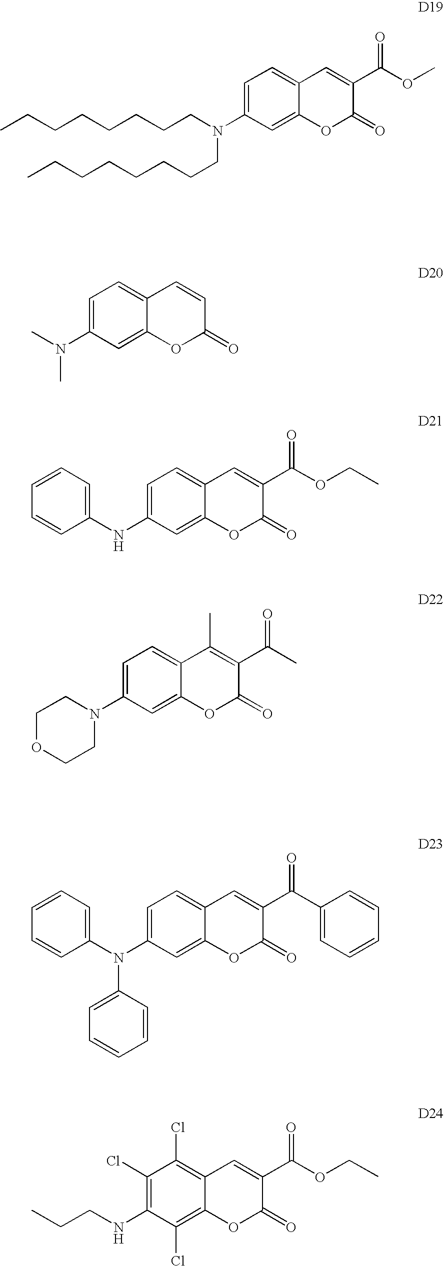

Other than the above specific examples, it is possible to employ coumarin derivatives B-1 through B-22 of JP-A No. 8-129258, coumarin derivatives D-1 through D-32 of JP-A No. 2003-21901, coumarin derivatives 1 through 21 of JP-A No. 2002-363206, coumarin derivatives 1 through 40 of JP-A No. 2002-363207, coumarin derivatives 1 through 34 of JP-A No. 2002-363208, and coumarin derivatives 1 through 56 of JP-A No. 2002-363209.

Successively described will be various additives capable of being added to photosensitive compositions in the present invention, supports as a photosensitive planographic printing plate, protective layers, coating of photosensitive compositions onto a support, and image recording methods of photosensitive planographic printing plates.

(Various Additives)

Other then the above components, in order to inhibit excessive polymerization of polymerizable ethylenic double bond monomers during production, or storage, of photosensitive planographic printing plates, it is preferable to incorporate polymerization inhibitors in the photosensitive compositions of the present invention. Listed as such appropriate polymerization inhibitors are hydroquinone, p-methoxyphenol, di-t-butyl-p-cresol, pyrogallol, t-butylcatechol, benzoquinone, 4,4′-thiobis(3-methyl-6-t-butylphenol), 2,2′-methylenebis(4-methyl-6-t-butylphenol), N-nitrosophenylhydroxylamine Ce(III) salts, and 2-t-butyl-6-(3-t-butyl-2-hydroxy-5-methylbenzyl)-4-methylphenyl acrylate.

The added amount of the polymerization inhibitors is preferably about 0.01-about 5% by weight with respect to the total solid weight of the above composition. Further, if desired, in order to minimize polymerization inhibition due to oxygen, behenic acid or higher fatty acid derivatives such as behenic acid amide may be incorporated or localized in the surface of the photosensitive layer during the drying process. The added amount of the higher fatty acid derivatives is preferably about 0.5-about 10% with respect to the total composition.

Further, it is possible to employ colorants. Appropriately employed as such colorants may be those known in the art, including commercial products. Examples include those described in “Ganryo Binran (Pigment Handbook)”, Revised New Edition, Edited by Nihon Ganryo Gijutsu Kyokai (Seibundo Shinkosha), and the Color Index Handbook.

Listed as types of pigments are black pigment, yellow pigments, red pigments, brown pigments, violet pigments, blue pigments, green pigments, fluorescent pigments, and metal powder pigments. Specific examples include inorganic pigments (titanium dioxide, carbon black, graphite, zinc oxide, Prussian blue, cadmium sulfide, and iron sulfide, as well as chromates of lead, zinc, barium, or calcium), in addition to organic pigments (such as azo based, thioindigo based, anthraquinone based, anthoanthrone based, or triphenedioxazine based pigments, vat dye pigments, phthalocyanine pigments and derivatives thereof, and quinacridone pigments).

Of these, are preferably employed pigments which exhibit no substantial absorption in the absorption wavelength region of spectral sensitizing dyes corresponding to the employed exposure laser beam. In such a case, the reflection absorption of pigments, which is determined employing an integrating sphere in the wavelength of the used laser beam, is at most 0.05. Further, the added amount of pigments is preferably 0.1-10% by weight with respect to the solids of the above composition, but is more preferably 0.2-5% by weight.

In view of pigment absorption in the above photosensitive wavelength region and image visibility, it is preferable to employ violet pigments and blue pigments. Listed as such pigments may, for example, be cobalt blue, cerulean blue, alkali blue lake, phonatone blue 6G, Victoria blue lake, metal-free phthalocyanine blue, phthalocyanine blue, first sky blue, indanthrene blue, indigo, dioxane violet, isoviotanthrone violet, indanthrone blue, and indanthrone BC. Of these, more preferred are phthalocyanine blue and dioxane violet.

Further, the above photosensitive composition may be incorporated surface active agents as a coatability enhancing agent in the range in which the performance of the present invention is not adversely affected. Of these, most preferred are fluorine based surface active agents.

Further, in order to improve physical properties of the hardened layer, incorporated may be additives such as inorganic fillers and plasticizers such as dioctyl phthalate, dimethyl phthalate, or tricresyl phosphate.

Still further, preferably listed as solvents employed in the photosensitive layer liquid coating composition, which is prepared to provide the photosensitive layer according to the present invention, are, for example, alcohols including polyhydric alcohol derivatives such as sec-butanol, isobutanol, n-hexanol, benzyl alcohol, diethylene glycol, triethylene glycol, tetraethylene glycol, 1,5-pentanediol; ethers such as propylene glycol monobutyl ether, dipropylene glycol monomethyl ether, or tripropylene glycol monomethyl ether; ketones; and esters such as ethyl lactate, butyl lactate, diethyl oxalate, or methyl benzoate.

In the above, described are photosensitive compositions according to the present invention. Photosensitive planographic printing plate materials according to the present invention are constituted by mixing each of the compositions described above and by coating the resulting mixture onto an aluminum support.

(Protective Layer: Oxygen Shielding Layer)

If desired, it is possible to provide a protective layer on the upper side of the photosensitive layer according to the present invention.

It is preferable that the above protective layer (being the oxygen shielding layer) exhibits high solubility in the developer (commonly being an aqueous alkali solution) described below. Listed as specific examples of components are polyvinyl alcohol and polyvinylpyrrolidone. Polyvinyl alcohol reduces penetration of oxygen, while polyvinyl secures adhesion to the photosensitive layer in contact.

If desired, employed together with the above two polymers are water-soluble polymers such as polysaccharide, polyethylene glycol, gelatin, glue, casein, hydroxyethyl cellulose, carboxymethyl cellulose, methyl cellulose, hydroxyethyl starch, gum Arabic, sucrose octaacetate, ammonium alginate, sodium alginate, polyvinylamine, polyethylene oxide, polystyrenesulfonic acid, polyacrylic acid, or water-soluble polyamide.

When a protective layer is provided on the photosensitive planographic printing plate material of the present invention, peel force between the photosensitive layer and the protective layer is preferably at least 35 mN/mm, is more preferably at least 50 mN/mm, but is still more preferably at least 75 mN/mm. Listed as preferred compositions of the protective layer are those described in JP-A No. 10-10742.

It is possible to determine the peel force as described below. A width-specified adhesive tape which exhibits sufficiently high adhesive force is adhered onto the protective layer. Subsequently, determined is the force to peel the tape together with the protective layer at an angle of 90 degrees with respect to the plane of the photosensitive planographic printing plate material.

If desired, it is possible to incorporate, into the protective layer, surface active agents and matting agents. The protective layer is formed in such a manner that the above protective layer compositions are dissolved in appropriate solvents and the resulting solution is applied onto the photosensitive layer followed by drying. It is particularly preferable that the main component of the coating solvents is water, or alcohols such as methanol, ethanol, or i-propanol.

When a protective layer is provided, its thickness is preferably 0.1-5.0 μm, but is most preferably 0.5-3.0 μm.

(Supports)

The photosensitive composition of the present invention is applied onto a support, whereby a photosensitive planographic printing plate material is constituted. Employed as supports of the present invention are those which carry a hydrophilic surface.

Employed as supports which carry the hydrophilic surface may be a support, which is subjected to hydrophilic treatment onto the surface of substrate, to carry a hydrophilic surface and a substrate provided with a hydrophilic layer incorporating hydrophilic materials.

Listed as supports according to the present invention are metal plates, plastic films, paper laminated with polyolefin, or composite substrates prepared by appropriately laminating the above materials.

The thickness of supports is not particularly limited, as long as they can be loaded in a printing press. However, supports of thickness of 80-500 μm are more easily manipulated.

Preferably employed as the supports according to the present invention are metal plates, the surface of which was subjected to hydrophilic treatment.

Listed as metal plates are those composed of iron, stainless steel, or aluminum. In the present invention, in view of the relationship between specific gravity and the stiffness, aluminum or an aluminum alloy (hereinafter referred to as aluminum plates including both) is preferred. Further, more preferred are those (so-called grained aluminum plates) which are subjected to any of a prior art surface roughening treatment, anodizing treatment, or hydrophilic surface treatment.

Employed as aluminum alloys may be various ones which include alloys of aluminum with metal such as silicon, copper, manganese, magnesium, chromium, zinc, lead, bismuth, nickel, titanium, sodium or iron.

It is preferable that prior to surface roughening (being a graining treatment), supports are subjected to degreasing to remove rolling oil on the surface. Employed as degreasing are degreasing employing solvents such as TRICHLENE or thinner and emulsion degreasing employing emulsions such as triethanol. Further, employed as degreasing may be an aqueous alkali solution incorporating sodium hydroxide. By employing an aqueous alkali solution incorporating sodium hydroxide, it is possible to remove stains and oxidized layers capable of being not removed only by the above degreasing. When the aqueous alkali solution incorporating sodium hydroxide is employed, smut is formed on the support surface. In such a case, it is preferable to perform desmut by immersing the treated support in acid such as phosphoric acid, nitric acid, sulfuric acid, chromic acid, or mixtures thereof.

The surface may be roughened employing an electrolysis method. However, prior to the electrolysis, it is possible, for example, to roughen the surface employing a mechanical method.

Employed mechanical surface roughening methods are not particularly limited, but a brush polishing method as well as a honing polishing method is preferred. Surface roughening employing the brush polishing method is, for example, performed as follows. A rotary brush composed of 0.2-0.8 mm brush bristles is pressed, while rotating, onto the surface of a support while feeding, onto the support surface, for example, a slurry which is prepared by uniformly dispersing, into water, 10-100 μm volcanic ash particles. On the other hand, surface roughening employing the honing polishing is, for example, performed in the following manner. Uniformly dispersed into water were 10-100 μm volcanic ash particles, and the resulting dispersion is obliquely ejected and collided onto the surface of the support from a nozzle under pressure, whereby the surface is roughened. Further, for example, the surface of a support is adhered to a sheet on which 10-100 μm abrasive particles are placed at a density of 2.5×10³-10×10¹⁰/cm² and an interval of 100-200 μm, and pressure is applied, whereby the surface can be roughed by transferring the rough surface pattern.

After surface roughening, employing the above mechanical surface roughening method, in order to remove any abrasive materials buried in the surface of the support and the abraded aluminum waste particles, it is preferable to immerse the resulting support into an aqueous acid or alkali solution. Employed as such acids are, for example, sulfuric acid, persulfuric acid, hydrofluoric acid, phosphoric acid, nitric acid, and hydrochloric acid, while employed as alkalis are, for example, sodium hydroxide and potassium hydroxide. The dissolved amount of aluminum on the surface is preferably 0.5-5 g/m². It is preferable that after immersing the support into the aqueous alkali solution, neutralization is performed by immersing the resulting support into phosphoric acid, nitric acid, sulfuric acid, chromic acid, or a mixture thereof.

Surface roughening may also be performed employing an electrolysis method in which surface roughening is electrochemically achieved in an acidic electrolyte. Surface roughening via electrolysis is performed in an acidic electrolyte such as a hydrochloric acid or nitric acid based solution at a concentration of at most 8% by weight at an effective current density of 30-100 A/dm² over 10-120 seconds. The concentration of hydrochloric acid or nitric acid is more preferably 1-2.3% by weight. The current density is more preferably 30-80 A/dm², but is still more preferably 40-75 A/dm².

In the present invention, use of aluminum supports which have been subjected to surface roughening, employing alternating current electrolysis, exhibit pronounced effects of the present invention, whereby in view of imaging speed and retention properties against staining, the above aluminum supports are preferably employed.

The temperature to conduct the above electrolysis surface roughening method is not particularly limited. However, it is preferable that the above method is employed in the range of 5-80° C., but it is more preferable that the temperature is selected from the range of 10-60° C. The applied voltage is also not particularly limited, and however, the applied voltage is preferably in the range of 10-50 volts but is more preferably in the range of 10-30 volts. The quantity of electricity is also not particularly limited. However, the employed quantity is preferably in the range of 100-5,000 c/dm², but is more preferably in the range of 100-2,000 c/dm².

If considered desirable, it is possible to incorporate, into an electrolyte, nitrates, chlorides, amines, aldehydes, phosphoric acid, chromic acid, boric acid, acetic acid, and oxalic acid.

After surface roughening employing the above electrolysis surface roughening method, it is preferable to immerse the resulting support into an aqueous acid or alkali solution to remove any aluminum waste particles. It is preferable to immerse the resulting support into an aqueous acid or alkali solution. Employed as acids are, for example, sulfuric acid, persulfuric acid, hydrofluoric acid, phosphoric acid, nitric acid, and hydrochloric acid, while employed as alkalis are, for example, sodium hydroxide and potassium hydroxide. The dissolved amount of aluminum on the surface is preferably 0.5-5 g/m². It is preferable that after immersing the support into the aqueous alkali solution, neutralization is performed by immersing the resulting support into phosphoric acid, nitric acid, sulfuric acid, chromic acid, or mixtures thereof.

Instead of an electrolysis surface roughening treatment, it is possible to employ an anodizing treatment. Anodizing treatment methods usable in the present invention are not particularly limited and it is possible to employ those known in the art.

To conduct an anodizing treatment, an oxidized layer is formed on the support. In the above anodizing treatment, a method is preferably employed in which electrolysis is performed at a current density of 1-10 A/dm², employing as an electrolyte, an aqueous solution containing sulfuric acid or phosphoric acid at a concentration of 10-50%. Other than the above, listed are: the method described in U.S. Pat. No. 1,412,768, in which electrolysis is conducted in sulfuric acid at a higher current density, and the method described in U.S. Pat. No. 3,511,661, in which electrolysis is performed employing phosphoric acid, and a solution containing at least one of chromic acid, oxalic acid, or malonic acid, or a mixture thereof. The anodized coverage amount is commonly 1-50 mg/dm², but is preferably 10-40 mg/dm². The anodized coverage amount is determined in such a manner that an aluminum plate is immersed into a phosphoric acid chromic acid solution (35 ml of a 85% phosphoric acid solution and prepared by dissolving 20 g of chromium(IV) oxide in 1 liter of water) to dissolve the oxidized layer and the weight difference between prior to and after the layer dissolution is recorded.

In this invention, it is preferable that after anodizing a support surface, the resulting surface is treated with a sodium silicate solution at a temperature of 20-50° C. The above temperature is preferably 20-50° C., but is more preferably 20-45° C. When the temperature is less than 20° C., stain removal occasionally becomes insufficient, while when it exceeds 50° C., plate life tends to be degraded. The concentration of sodium silicate is not particularly limited, but it is preferably 0.01-35%, but is more preferably 0.1-5%.

In the present invention, it is preferable that after the anodizing treatment, the support is treated with a polyvinylphosphonic acid solution at a temperature of 20-70° C. The above temperature is preferably 20-70° C., but is more preferably 30-65° C. When the temperature is less than 20° C., stain removal occasionally becomes insufficient, while when it exceeds 70° C., plate life tends to be degraded. The concentration of the polyvinylphosphonic acid solution is not particularly limited, but the above concentration is preferably 0.01-35%, but is more preferably 0.1-5%.

Listed as plastic films employed as a support may be those composed of polyethylene terephthalate, polyethylene naphthalate, polyimide, polycarbonate, polysulfone, polyphenylene oxide, or cellulose ester.

In the present invention, of these, preferably employed as a substrate, are plastic films, polyester films composed of polyethylene terephthalates or polyethylene naphthalates.

(Coating)

A prepared photosensitive composition (being a photopolymerizable photosensitive layer liquid coating composition) is applied onto a support employing an appropriate method known in the art and subsequently dried to form a photosensitive layer, whereby it is possible to produce a photosensitive planographic printing plate material. Listed as coating methods are, for example, an air doctor coater method, a blade coater method, a knife coater method, a dip coater method, a reverse roller coater method, a gravure coater method, a cast coating method, a curtain coater method, and an extrusion coater method.

A low drying temperature to form the photosensitive layer results in insufficient printing life, while an excessively high drying temperature results in not only Marangoni but also fogging in non-image portions. The drying temperature is preferably in the range of 60-160° C., is more preferably in the range of 80-140° C., but is most preferably in the range of 90-120° C.

(Image Forming Method)

Preferred as a light source which is employed to form images on the photosensitive planographic printing plate material according to the present invention is one which emits a 1350-450 nm laser beam.

Listed as light sources which are employed to achieve exposure onto the photosensitive planographic printing plate materials of the present invention may, for example, be a He—Cd laser (441 nm), a combination (430 nm) of Cr:LiSAF with SHG crystals as a solid laser), KNbO₃ as a semiconductor laser system), a ring resonator (430 nm), AlGaInN (350-410 nm), and AlGaInN semiconductor laser (commercially available InGaN based semiconductor laser in the range of 400-410 nm).

Via exposure employing a laser beam, it is possible to perform scanning exposure corresponding to the image data while light is focused into a beam, whereby it is suitable for direct writing without using masking materials.

Further, when a laser is employed as a light source, it is easy to decrease the exposure area to a tiny size, whereby it becomes possible to form images of high resolution.

Laser scanning methods include outer cylinder surface scanning, inner cylinder surface scanning, and plane scanning. In the outer cylinder surface scanning, a laser beam is exposed onto a planographic printing plate material, which is wound on the exterior surface of a rotating drum. The drum rotation is referred to as primary scanning, while the movement of the laser beam is referred to as secondary scanning. In inner cylinder surface scanning, a planographic printing plate material is fixed on the inner surface of a drum. A laser beam is irradiated from the inner side so that primary scanning is performed in the peripheral direction by rotating a part of or the entire optical system, while secondary scanning is performed in the axial direction by linearly moving a part of or the entire optical system parallel to the axis of the drum. In the plane scanning, primary scanning of a laser beam is performed by combining a polygonal mirror, a galvanic mirror, and an fθ lens, while secondary scanning is performed by movement of the recording medium. Cylinder outer surface scanning and cylinder inner surface scanning are suitable for high density recording, since both of the optical accuracy are easily enhanced.

In the present invention, it is preferable that images are recorded at the plate surface energy (being the energy on the plate material) of at least 10 mJ/cm², while its upper limit is 500 mJ/cm². It is possible to determine the above energy employing, for example, LASER POWER METER PDGDO-3W, produced by Ophir Optronics Co.

(Developer)

In an image formed photosensitive layer, exposed portions are hardened. When an exposed material is developed employing a developer, unexposed portions are removed, whereby a printing plate is prepared. Employed as such a developer may be a conventionally known aqueous alkali solution. Listed as such a developer are alkali developers which employ inorganic alkali agents such as sodium, potassium, or ammonium silicate; sodium, potassium, or ammonium bicarbonate; sodium, potassium, or ammonium carbonate; and sodium, potassium, or ammonium borate; sodium, potassium, ammonium, or lithium hydroxide.

Further, it is possible to employ organic alkali agents such as monomethylamine, dimethylamine, trimethylamine, monoethylamine, diethylamine, triethylamine, mono-i-propylamine, di-i-propylamine, tri-i-propylamine, butylamine, monoethanolamine, diethanolamine, triethanolamine, mono-i-propanolamine, di-i-propanolamine, ethyleneimine, ethylenediamine, or pyridine.

These alkali agents may be employed individually or in combinations of at least two types. Further, if desired, incorporated in the above developer may be anionic surface active agents, amphoteric surface active agents, and organic solvents such as alcohol.

(Automatic Processor)

It is beneficial to employ an automatic processor to develop photosensitive planographic printing plate materials. It is preferable that the above automatic processor is provided with the following mechanisms: a mechanism to automatically replenish the necessary amount of developer replenisher to the development bath; a mechanism to automatically replenish the necessary amount of water to the development bath; a mechanism to detect the passage of plates; a mechanism to estimate the processing plate area based on the detection of the plate passage; a mechanism to control the replenishment rate of the replenisher and/or water, and/or the replenishment timing based on the detection of plate passage and/or the estimation of the processing area; a mechanism to control the temperature of the developer; a mechanism to monitor the pH and/or the conductivity of the developer; and a mechanism to control the replenishment rate of the developer and/or water, and/or the replenishment timing of the replenisher and/or water based on the pH and/or the conductivity of the developer. Further, it is also preferable that the above processor exhibits a function which temporarily dilutes a developer concentrate with water while stirring. In the case in which a washing step follows the development step, it is possible to employ the effluent of the washing water to dilute the developer concentrate.

The automatic processor may include a pre-processing section which immerses a plate into a pre-processing solution prior to the development step. The above pre-processing section is preferably provided with: a mechanism to spray the pre-processing solution onto the plate surface; a mechanism to control the temperature of the pre-processing solution to temperature between 25-55° C.; and a mechanism to rub the plate surface with a rotary brush. Water is commonly employed as the above pre-processing solution.

(Post-Processing)

A planographic printing plate, which has been developed via a developer, is subjected to post-processing employing washing water, a rinsing solution incorporating surface active agents, a finisher incorporating gum Arabic and starch derivatives as a major component, or a protective gum solution. It is possible to variously combine and use these processing steps. For example, a processing step such as development→water washing→surface active agent containing rinsing or development→water washing→finisher is preferred since the rinsing solution or finisher is less exhausted. Further, a cascaded counter-current process is a preferred embodiment.

Such post-processing steps are commonly performed employing an automatic processor composed of a development section and a post-processing section. Post-processing steps are realized employing such a method that a post-processing solution is sprayed from a spray nozzle, or conveyance is carried out while immersed in a processing tank filled with a processing solution. Further, it is known that after development, washing can be performed by feeding a small and specified amount of water onto the plate surface and the resulting effluent can be re-used as dilution water for the developer stock solution. In such automatic processing, it is possible to perform processing while replenishing each of the replenishers to each of the processing solutions, corresponding to the processing amount and operation time. Further, it is possible to employ a so-called non-reusable system in which processing is performed employing a fresh post-processing solution. Planographic printing plates prepared employing the above processes are mounted on an offset printing press and employed for printing a large number of sheets.

(Gum Solution)

Preferably added to the gum solution are acids or buffering agents to remove alkali components of the developer. Other than the above, it is possible to add hydrophilic polymer compounds, chelating agents, lubricants, antiseptics, and solubilizing agents. Hydrophilic polymer compounds incorporated in the gum solution can also function as a protective agent which minimizes abrasion and staining on the plate after development.

(Pre-Development Washing Water)

The washing solution (being a pre-processing solution), employed in the pre-processing section such as a pre-development washing process, is commonly water. If required, added may be additives such as chelating agents, surface active agents, or antiseptics.

In the above washing method, it is preferable to employ a washing solution used in pre-development washing upon controlling the temperature, which is preferably in the range of 10-60° C. Employed as a washing method may be prior art processing solution feeding techniques such as spraying, dipping, or coating. Further, it is possible to use process-enhancing means such as an appropriate brush, a squeezed roller, or an in-solution shower in the dipping process.

Development may be performed immediately after the completion of the pre-development washing process, or after drying which follows the pre-development washing process. After development, it is possible to perform prior art post-processing such as water washing, rinsing, or gum application. It is possible to re-use pre-development washing water once used as post-development washing water or in the rinsing solution and the gum solution.

### EXAMPLES

The present invention will now be detailed with reference to examples, however the embodiments of the present invention are not limited thereto. In the examples, “parts” are “parts by weight”, unless otherwise specified.

### Example 1

<<Polymer Binder: Synthesis of Acryl Based Copolymer 1>>

Under a nitrogen atmosphere, charged into a three-necked flask were 30 parts of methacrylic acid, 50 parts of methyl methacrylate, 20 parts of ethyl methacrylate, 500 parts of isopropyl alcohol, and 3 parts of α,α′-azobisisobutyronitrile, and the resulting mixture underwent reaction under a nitrogen atmosphere at 80° C. for 6 hours in an oil bath.

Thereafter, after refluxing was performed at the boiling point of isopropyl alcohol over one hour, 3 parts of triethylammonium chloride and 25 parts of glycidyl methacrylate were added, and the resulting mixture underwent reaction for 3 hours, whereby Acryl Based Copolymer 1 was obtained. Its weight average molecular weight was determined employing GCP, resulting in about 35,000, while its glass transition temperature (Tg) was determined employing DSC (being a differential thermal analysis method), resulting in about 85° C.

(Preparation of the Support)

A 0.30 mm thick and 1,030 mm wide aluminum plate according to JIS A 1050 was continuously treated as follows.

(a) The above aluminum plate was subjected to a spray etching treatment at conditions of 70° C., a sodium hydroxide concentration of 2.6% by weight, and an aluminum ion concentration of 6.5% by weight, whereby the aluminum plate was subjected to dissolution at 0.3 g/m². Thereafter, water washing was performed employing a spray.

(b) A desmut treatment was performed by spraying a 1% by weight aqueous nitric acid solution (containing 0.5% by weight of aluminum ions) at 30° C., followed by water washing employing a spray.

(c) An electrochemical surface roughening treatment was continuously performed employing a 60 Hz alternating current. During this treatment, the electrolyte incorporated 1.1% by weight of hydrochloric acid, 0.5% by weight of aluminum ions, and 0.5% by weight of acetic acid. The temperature was maintained at 21° C. The electrochemical surface roughening treatment was performed employing a sinusoidal current, which resulted in 2 msec of TP time during which the current value reached from zero to the peak, and also employing a carbon electrode as a counter electrode. Current density was 50 A/dm² in terms of an effective value, while the quantity of electricity was 9,000 C/dm². Thereafter, water washing was performed employing a spray.

(d) A desmut treatment was performed for 10 seconds, employing a 20% by weight aqueous phosphoric acid solution (containing 0.5% by weight of aluminum ions) at 60° C., followed by water washing employing a spray.

(e) An anodizing treatment was performed via a sulfuric acid concentration of 170 g/l (containing 0.5% by weight of aluminum ions) in the electrolysis section at 30° C., employing an anodizing apparatus (of a length of each of the first and second electrolysis sections of 6 m, of a length of the first and second feeding sections of 3 m, and of a length of each of the first and second feeding electrodes of 2.4 m), followed by water washing employing a spray.

During the above treatment, in the anodizing apparatus, an electric current from a power source was routed to the first feeding electrode installed in the first feeding section and was further routed to an aluminum plate via the electrolyte. In the first electrolysis section, an oxidized layer was formed on the aluminum plate surface and the resulting current passed through the electrolysis electrode installed in the first feeding section, and routed back to the power source.

On the other hand, an electric current from the power source was routed to the second feeding electrode installed in the second feeding section, and in the same manner as above, routed to an aluminum plate via the electrolyte. In the second electrolysis section, an oxidized layer was formed on the aluminum plate surface in the second electrolysis section. The quantity of electricity fed from the power source to the first feeding section was the same as that fed from the power source to the second feeding section, and the fed current density on the oxidized layer in the second feeding section was about 35 A/dm². In the second feeding section, current was fed from the oxidized layer surface of 1.35 g/m².

The final weight of the oxidized layer was 2.7 g/m². Further, after spray washing, the resulting plate was immersed into a 0.4% by weight polyvinylsulfonic acid solution for 30 seconds, whereby a hydrophilic treatment was performed. The temperature was 75° C. Thereafter, spray washing was performed, followed by drying employing an infrared heater.

The resulting center line mean roughness (Ra) was 0.65 μm.

(Preparation of Photosensitive Planographic Printing Plate Materials)

The photopolymerizable photosensitive layer liquid coating composition, composed as described below, was applied onto the above support, employing a wire bar coater to result in a dried coated weight of 1.5 g/m², and subsequently dried at 100° C. for 1.5 minutes, whereby a photopolymerizable photosensitive layer coating sample was obtained.

Further, the oxygen shielding layer liquid coating composition, composed as described below, was applied onto the photopolymerizable photosensitive layer coated sample, employing a wire bar coater to result in a dried coated weight of 1.5 g/m², and subsequently dried at 75° C. for 1.5 minutes, whereby Photosensitive Planographic Printing Plate Samples 1-7 incorporating the oxygen shielding layer on the photosensitive layer were prepared.

(Photopolymerizable Photosensitive Layer Liquid Coating
Composition)

| Acryl Based Copolymer 1 | 40.0 | parts |
|---|---|---|
| Addition polymerizable ethylenic double | 30.0 | parts |
| bond containing compound (M-3) | | |
| having a tertiary amino group in | | |
| the molecule) | | |
| Polyethylene glycol #200 dimethacrylate | 10.0 | parts |
| (NK ESTER 4G, produced by Shin- | | |
| Nakamura Chemical Co., Ltd.) | | |
| Sensitizing dye (Dye 1, described below) | 3.0 | parts |
| Photopolymerization initiator (described | Amount described in Table | |
| in Table 1) | 1 | |
| Mercaptobenzimidazole | 1.0 | part |
| Compound I-29 described below | 1.5 | parts |
| Hindered amine stabilizer (L5770, produced | Amount described in Table | |
| by Sankyo Life Tech Co.) | 1 | |
| Phthalocyanine pigment (MHI454, produced | 6.0 | parts |
| by Mikuni Color Co.) | | |
| Siloxane glycol copolymer (described in | Amount described in Table | |
| Table 1) | 1 | |
| Methyl ethyl ketone | 80 | parts |
| Cyclohexanone | 820 | parts |

Dye 1

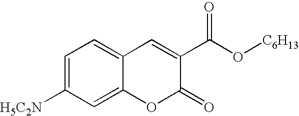

I-29

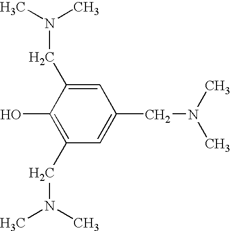

(Oxygen Shielding Layer Liquid Coating Composition)

| | | |
|---|---|---|
| Polyvinyl alcohol (GL-05, produced by | 84 | parts |
| Nippon Synthetic Chemical Industry | | |
| Co., Ltd.) | | |
| Polyvinylpyrrolidone (k-30, produced by | 15 | parts |
| ISP Japan Co.) | | |
| Surface active agent (SURFINOL 465, | 0.5 | part |
| produced by Nissin Chemical Corp.) | | |
| Water | 900 | parts |

(Image Forming Method)

The photopolymerizable planographic printing plate material, prepared as above, was equally divided into two parts. One was stored in an ambience of 23° C. and 55% relative humidity for 3 days, while the other was also stored in an ambience of 40° C. and 80% relative humidity for 3 days. Thereafter, images were formed employing the methods described below.

Image exposure was performed at a resolution of 2,400 dpi (dpi, as described herein, refers to the number of dots per 1 inch, namely 2.54 cm), employing a CPT exposure apparatus (TIGERCAT, produced by ECRM Co.) fitted with a laser beam source at an output of 30 mW and a 408 nm wavelength. The exposed image included a 100% solid image exposed portion and a 1-99% halftone image.

Subsequently, development was performed employing a CPT automatic processor (PHW23-V, produced by Technigraph Co.), provided with a heating apparatus section prior to development, a pre-washing section which removed the overcoat layer, a development section loaded with Developer Composition 1, described below, a washing section which removed the developer adhered to the plate surface, and a gum solution (GW-3, produced by Mitsubishi Chemical Corp. and in practice, employed by diluting it by a factor of two). Conditions in the heating section were controlled so that the surface temperature of a 0.3 mm plate reached 105° C. Further, heating time was controlled to 15 seconds. Developer Composition 1 (aqueous solution incorporating the following additives)

| | |
|---|---|
| A potassium silicate | 8.0% by weight |
| NEWCOAL B-13SN (produced by Nippon | 2.0% by weight |
| Nyukazai Co.) | |
| PRONON #204 (produced by NOF Corp.) | 1.0% by weight |
| Disodium ethylenediaminetetraacetate | 0.1% by weight |
| dihydrate | |
| Potassium hydroxide | amount to control |
| | the pH to 12.3 |

<<Evaluation of Planographic Printing Plates>>
(Suction Cup Contact Stain)

In the CTP exposure apparatus employed for image formation, conveyance of the plate from the plate loading cassette to the inner drum to be exposed by a laser beam and its positioning was performed employing a working arm having a positioning suction cup. During such an operation, the image forming side of the plate is stuck by the suction cup. Consequently, a 50% halftone image was exposed on the portion which was stuck by the suction cup so that its portion was easily detected, whereby evaluation was conducted. A visual 5-rank evaluation was conducted based on the following criteria.
5: No trace of the suction cup was noticed
4: A slight trace of the suction cup was visible, but the resulting print was commercially viable
3: A trace of the suction cup was noted somewhat, but the resulting print was commercially viable
2: A clear trace of the suction cup was noted, and the resulting print was not commercially viable
1: A definite trace of the suction cup was noticed, and the resulting print was not commercially viable
   (Imaging Speed)

While changing the laser beam exposure energy, a 100% solid color image density was determined at each of the exposure energies. Subsequently, the minimum image forming energy to result in a density (reflection density) which was 10% lower than the maximum solid density (reflection density) was determined, and the resulting value was designated as the index of imaging speed.

<<Ink Stain>>

An image formed plate was loaded in a printing press (DAIYA 1F-1, produced by Mitsubishi Heavy Industries, Ltd.), and printing was performed employing coated paper, a printing ink (TOYO KING HIGH ECHO M BENI, produced by Toyo Ink Mfg. Co., Ltd.), and dampening water (H SOLUTION SG-51 at a concentration of 1.5%, produced by Tokyo Ink Mfg. Co., Ltd.). Formation of ink stain spots in non-image portions on the 100th print was visually evaluated based on the following 5-rank criteria.
5: No ink stain was noticed in non-image portions
4: When viewed employing a 30 power hand magnifying lens, ink stains were noticed, but the resulting print was commercially viable
3: Slight ink stains were noticed in the non-image portions, but the resulting print was commercially viable
2: Definite ink stains were noticed in non-image portions, and the resulting print was not commercially viable
1: Significant ink stains were noticed in non-image portions, and the resulting print was not commercially viable

Table 1 shows the results. As can clearly be seen from Table 1, the photosensitive planographic printing plate materials of the present invention minimized the suction cup trace stains, exhibited desired imaging speed as well as retention properties of ink stain resistance.

TABLE 1

| | | | | Siloxane | | | | | Ink Stain | |
|---|---|---|---|---|---|---|---|---|---|---|
| Photosensitive | | Photopolymerization | | Glycol | | | Imaging speed | | Resistance | |
| Planographic | | Initiator | | Copolymer | | | μj/cm² | | Rank | |
| Printing Plate | | | Added | | Added | | 23° C. | 40° C. | 23° C. | 40° C. |
| Sample | Remark | Type | Amount | Type | Amount | *1 | 55% RH | 80% RH | 55% RH | 80% RH |
| 1 | Comp. | Compound b | 10.0 | A | 0.3 | 1 | 50 | 100 | 5 | 1 |
| 2 | Inv. | Compound a | 3.0 | A | 0.3 | 5 | 50 | 53 | 5 | 5 |
| 3 | Inv. | Compound a | 3.0 | B | 0.4 | 5 | 50 | 45 | 5 | 5 |
| 4 | Inv. | Compound a | 3.0 | C | 0.2 | 5 | 50 | 55 | 5 | 5 |
| 5 | Inv. | Compound a | 3.0 | D | 0.3 | 5 | 50 | 53 | 5 | 5 |
| 6 | Inv. | Compound a | 3.0 | E | 0.1 | 5 | 50 | 48 | 5 | 5 |
| 7 | Comp. | Compound a | 3.0 | — | — | 1 | 70 | 100 | 3 | 1 |

Comp.: Comparative Example, Inv.: Present Invention
*1: Stain Resistance Rank of Suction Cup Trace
Compound a: η-cumene-(η-cyclopentadienyl)iron
hexafluorophosphate
Compound b: 2,2′-bis(o-chlorophenyl)-4,4′,5,5′-
tetraphenylimidazole

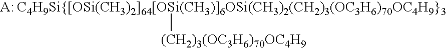

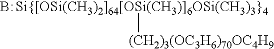

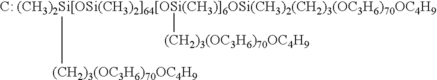

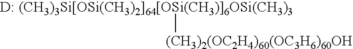

E: EDAPLAN LA411 (produced by Munzing Chemie Co.)

What is claimed is:

1. A photosensitive composition comprising:
(A) an addition-polymerizable compound containing an ethylenic double bond in the molecule;
(B) an iron-arene complex which acts as a photopolymerization initiator;
(C) a polymer binder; and
(E) a siloxane glycol copolymer.

2. The photosensitive composition of claim 1,
wherein the siloxane glycol copolymer is represented by one of Formulas (1), (2), (3) and (4):
RₐSi[(OSiMe₂)ₙ(OSiMeG)_{b}OSiMe₂G]₄₋ₐ Formula (1)
RₐSi[(OSiMe₂)ₙ(OSiMeG)_{c}OSiMe₃]₄₋ₐ Formula (2)
GMe₂Si(OSiMe₂)ₙ(OSiMeG)_{b}OSiMe₂G Formula (3)
Me₃Si(OSiMe₂)ₙ(OSiMeG)_{c}OSiMe₃ Formula (4)
in Formulas (1)-(4), Rₐ represents a hydrocarbon group having 1-10 carbon atoms containing no aliphatic unsaturated group; Me represents a methyl group; G represents -D(OR¹)ₘA where D represents an alkylene group having 1-30 carbon atoms, R¹ represents an alkylene group having 2-10 carbon atoms, while m represents an integer of 1 or more, A represents a capping group; a represents an integer of 0 or 1, n represents a value of 12 or more; b represents a value of 0-50; and c represents a value of 1-50.

3. The photosensitive composition of claim 1,
further comprising (D) a dye exhibiting an absorption maximum wavelength of 350-450 nm.

4. A photosensitive planographic printing plate material comprising a support having thereon a photosensitive layer comprising the photosensitive composition of claims 1.

5. The photosensitive planographic printing plate material of claim 4,
wherein the support is an aluminum substrate which has been subjected to alternating current surface roughening in an electrolyte comprising hydrochloric acid.

6. An image forming method of a planographic printing plate material comprising the step of:
imagewise exposing the photosensitive planographic printing plate material of claim 4 with a light source which emits a laser beam having a wavelength of 350-450 nm.
